(19) United States
(12) Patent Application Publication
(10) Pub. No.: US 2025/0351106 A1
(43) Pub. Date: Nov. 13, 2025

(54) APPARATUS AND METHOD FOR PROVIDING NON-TERRESTRIAL NETWORK (NTN) SUPPORT FUNCTION IN WIRELESS COMMUNICATION SYSTEM

(71) Applicant: ELECTRONICS AND TELECOMMUNICATIONS RESEARCH INSTITUTE, Daejeon (KR)

(72) Inventors: Seung Han CHOI, Daejeon (KR); Namseok KO, Daejeon (KR)

(73) Assignee: ELECTRONICS AND TELECOMMUNICATIONS RESEARCH INSTITUTE, Daejeon (KR)

(21) Appl. No.: 19/087,043

(22) Filed: Mar. 21, 2025

(30) Foreign Application Priority Data
May 10, 2024 (KR) 10-2024-0061987
Mar. 7, 2025 (KR) 10-2025-0029969

(51) Int. Cl. H04W 60/00; H04W 84/06

(52) U.S. Cl. CPC H04W 60/00; H04W 84/06

(57) ABSTRACT

This disclosure generally relates to wireless communication systems, and more specifically to an apparatus and method for providing Non-Terrestrial Network (NTN) support functions in wireless communication systems. A method performed by an Access and Mobility Management Function (AMF) for providing Non-Terrestrial Network (NTN) support function information in a wireless communication system may include: registering NTN support information including NTN support functions by the AMF to a Network Repository Function (NRF) through a Service Based Interface (SBI); and enabling other Network Functions (NF) to search for the AMF including NTN support functions from the NRF through the SBI.

### CROSS REFERENCE TO RELATED APPLICATION

The present application claims priority to Korean Patent Application No. 10-2024-0061987, filed on May 10, 2024, and Korean Patent Application No. 10-2025-0029969, filed on Mar. 7, 2025, the entire contents of which are incorporated herein for all purposes by this reference.

### BACKGROUND OF THE INVENTION

### Field of the Invention

This disclosure generally relates to wireless communication systems, and more specifically to an apparatus and method for providing Non-Terrestrial Network (NTN) support functions in wireless communication systems.

### Description of the Related Art

Wireless communication systems, including 5G communication systems, aim to provide network infrastructure capable of high data transmission rates and extensive service coverage. This requires a Network Repository Function (NRF) for efficient management and interaction of Network Functions (NF). Additionally, the ability to provide 5G services in areas not reached by terrestrial networks through Non-Terrestrial Networks (NTN) is necessary. Furthermore, data processing and coordination through Service Based Interfaces (SBI) and N4 interfaces between various network functions are essential.

Current implementation methods of 3GPP 5G systems include NFs such as Access and Mobility Management Function (AMF), Session Management Function (SMF), Policy Control Function (PCF), and User Plane Function (UPF) operating according to standardized procedures. Standardization work considering NTN is in progress in Rel-16/17/18/19, including approaches to complement the limitations of terrestrial networks through satellite-based services.

NTN can provide useful 5G services in areas where terrestrial 5G networks are not serviced or are vulnerable, due to extensive service coverage and reduced vulnerability to physical attacks and natural disasters by utilizing space/aviation platforms. Furthermore, NTN is expected to impact various fields including transportation, public safety, media and entertainment, eHealth, energy, agriculture, factories, and automotive through integrated terrestrial and non-terrestrial networks.

However, in 3GPP Rel-16/17/18/19, there is a problem that specific methods for other NFs to search for or utilize AMF, SMF, PCF, and UPF with NTN support functions are not defined.

### SUMMARY OF THE INVENTION

Based on the discussion above, this disclosure provides an apparatus and method for efficiently registering Network Functions (NF) with Non-Terrestrial Network (NTN) support capabilities in wireless communication systems.

Furthermore, this disclosure provides an apparatus and method to enable other NFs to search for Access and Mobility Management Functions (AMF) with NTN support capabilities through the Network Repository Function (NRF) in wireless communication systems.

Additionally, this disclosure provides an apparatus and method to enable other NFs to search for Session Management Functions (SMF) with NTN support capabilities through the NRF in wireless communication systems.

Moreover, this disclosure provides an apparatus and method to enable other NFs to search for Policy Control Functions (PCF) with NTN support capabilities through the NRF in wireless communication systems.

Furthermore, this disclosure provides an apparatus and method to optimize the Association Setup procedure between SMF and User Plane Functions (UPF) with NTN support capabilities through the N4 interface in wireless communication systems.

### Means for Solving the Problems

According to various embodiments of this disclosure, a method performed by an Access and Mobility Management Function (AMF) for providing Non-Terrestrial Network (NTN) support function information in a wireless communication system may include: registering NTN support information including NTN support functions to a Network Repository Function (NRF) through a Service Based Interface (SBI); and enabling other Network Functions (NF) to search for the AMF including NTN support functions from the NRF through the SBI.

According to various embodiments of this disclosure, an operation method of a Session Management Function (SMF) for providing Non-Terrestrial Network support function information in a wireless communication system may include: registering NTN support information through a Service Based Interface (SBI) to a Network Repository Function (NRF); and enabling Network Functions (NF) to search for the SMF with NTN support information from the NRF through the SBI.

According to various embodiments of this disclosure, an operation method of a User Plane Function (UPF) for providing Non-Terrestrial Network support function information in a wireless communication system may include: registering NTN support information through a Service Based Interface (SBI) to a Network Repository Function (NRF); and enabling Network Functions (NF) to search for the UPF with NTN support information from the NRF through the SBI.

According to various embodiments of this disclosure, an Access and Mobility Management Function (AMF) for providing Non-Terrestrial Network (NTN) support function information in a wireless communication system includes: a transceiver; and a processor connected to the transceiver, wherein the processor registers NTN support information including NTN support functions to a Network Repository Function (NRF) through a Service Based Interface (SBI), and enables other Network Functions (NF) to search for the AMF including NTN support functions from the NRF through the SBI.

The apparatus and method according to various embodiments of this disclosure provide a method for other NFs to find AMF (Access and Mobility Management Function), SMF (Session Management Function), PCF (Policy Control Function), and UPF (User Plane Function) with NTN support functions, which are not available in the current 5G system. By enabling AMF, SMF, PCF, and UPF with NTN support functions to register with the Network Repository Function (NRF) and making them searchable, other NFs can efficiently find AMF, SMF, PCF, and UPF with NTN support functions.

Furthermore, the apparatus and method according to various embodiments of this disclosure enable SMF and UPF with NTN support functions to perform the Association Setup procedure through the N4 interface, thereby improving the efficiency and stability of data transmission in the NTN environment.

The effects that can be obtained from this disclosure are not limited to the effects mentioned above, and other effects not mentioned will be clearly understood by those skilled in the art to which this disclosure pertains from the following description.

### BRIEF DESCRIPTION OF THE DRAWINGS

FIG. 1 illustrates a 5G system architecture with service-based architecture according to various embodiments of this disclosure.

FIG. 2 illustrates a 5G system architecture supporting Satellite Access RAN according to various embodiments of this disclosure.

FIG. 3A illustrates a procedure for AMF to register with NRF according to various embodiments of this disclosure.

FIG. 3B illustrates NFProfile information that AMF registers with NRF according to an embodiment of this disclosure.

FIG. 3C illustrates amfInfo information that AMF registers with NRF according to an embodiment of this disclosure.

FIG. 3D illustrates a procedure for NF to search for AMF from NRF according to various embodiments of this disclosure.

FIG. 4A illustrates a procedure for SMF to register with NRF according to an embodiment of this disclosure.

FIG. 4B illustrates NFProfile information that SMF registers with NRF according to various embodiments of this disclosure.

FIG. 4C illustrates smfInfo information that SMF registers with NRF according to various embodiments of this disclosure.

FIG. 4D illustrates a procedure for NF to search for SMF from NRF according to various embodiments of this disclosure.

FIG. 5A illustrates a procedure for PCF to register with NRF according to an embodiment of this disclosure.

FIG. 5B illustrates NFProfile information that PCF registers with NRF according to an embodiment of this disclosure.

FIG. 5C illustrates pcfInfo information that PCF registers with NRF according to an embodiment of this disclosure.

FIG. 5D illustrates a procedure for NF to search for PCF from NRF according to an embodiment of this disclosure.

FIG. 6A illustrates a procedure for UPF to register with NRF according to various embodiments of this disclosure.

FIG. 6B illustrates NFProfile information that UPF registers with NRF according to an embodiment of this disclosure.

FIG. 6C illustrates upfInfo information that UPF registers with NRF according to various embodiments of this disclosure.

FIG. 6D illustrates a procedure for NF to search for UPF from NRF according to various embodiments of this disclosure.

FIG. 7 illustrates UP Function Features according to various embodiments of this disclosure.

FIG. 8 illustrates an Association Setup procedure between SMF and UPF according to various embodiments of this disclosure.

FIG. 9 illustrates access and mobility management function information including NTN support functions according to an embodiment of this disclosure.

FIG. 10 illustrates a procedure for AMF including NTN support functions to register with NRF according to an embodiment of this disclosure.

FIG. 11 illustrates a procedure for NF to search for AMF including NTN support functions from NRF according to an embodiment of this disclosure.

FIG. 12 illustrates session management function information (smfInfo) including NTN support functions according to an embodiment of this disclosure.

FIG. 13 illustrates a procedure for SMF including NTN support functions to register with NRF according to an embodiment of this disclosure.

FIG. 14 illustrates a procedure for NF to search for SMF including NTN support functions from NRF according to an embodiment of this disclosure.

FIG. 15 illustrates policy control function information (pcfInfo) including NTN support functions according to an embodiment of this disclosure.

FIG. 16 illustrates a procedure for PCF including NTN support functions to register with NRF according to an embodiment of this disclosure.

FIG. 17 illustrates a procedure for NF to search for PCF including NTN support functions from NRF according to an embodiment of this disclosure.

FIG. 18 illustrates user plane function information (upfInfo) including NTN support functions according to an embodiment of this disclosure.

FIG. 19 illustrates UP Function Features including NTN support Features for UPF of 5G system to provide UP Function Features information to NRF or SMF according to an embodiment of this disclosure.

FIG. 20 illustrates a procedure for user plane function (UPF) including NTN support Features of 5G system to register with network repository function (NRF) according to an embodiment of this disclosure.

FIG. 21 illustrates a procedure for NF of 5G system to search for UPF including NTN support Features from NRF according to an embodiment of this disclosure.

FIG. 22 illustrates a procedure for UPF to provide UP Function Features including NTN support Features to SMF in the Association Setup procedure of SMF and UPF of 5G system according to an embodiment of this disclosure.

FIG. 23 illustrates a method for registration and search of AMF including NTN support functions according to an embodiment of this disclosure.

FIG. 24 illustrates a method for registration and search of SMF including NTN support functions according to an embodiment of this disclosure.

FIG. 25 illustrates a method for registration and search of UPF including NTN support functions according to an embodiment of this disclosure.

FIG. 26 illustrates a configuration of a base station in a wireless communication system according to various embodiments of this disclosure.

FIG. 27 illustrates a configuration of a terminal in a wireless communication system according to various embodiments of this disclosure.

FIG. 28 illustrates a configuration of a network entity in a wireless communication system according to various embodiments of this disclosure.

### DETAILED DESCRIPTION OF THE INVENTION

The terms used in this disclosure are used to describe particular embodiments and are not intended to limit the scope of other embodiments. Singular expressions may include plural expressions unless the context clearly indicates otherwise. Technical or scientific terms used herein may have the same meaning as commonly understood by those skilled in the art to which this disclosure pertains. Terms defined in general dictionaries may be interpreted as having the same or similar meanings as understood in the context of the relevant technology, and unless explicitly defined in this disclosure, they should not be interpreted in an idealized or overly formal sense. In some cases, even terms defined in this disclosure should not be interpreted to exclude embodiments of this disclosure.

In the various embodiments of this disclosure described below, hardware approaches are exemplified. However, since the various embodiments of this disclosure include technology using both hardware and software, the various embodiments of this disclosure do not exclude software-based approaches.

Furthermore, in the detailed description and claims of this disclosure, “at least one of A, B, and C” may mean “only A”, “only B”, “only C”, or “any combination of A, B, and C”. Also, “at least one of A, B, or C” or “at least one of A, B, and/or C” may mean “at least one of A, B, and C”.

This disclosure relates to methods for providing NonF-Terrestrial Network (NTN) support functions for Network Functions (NF) in the 3GPP 5G system, specifically AMF (Access and Mobility Management Function), SMF (Session Management Function), UPF (User Plane Function), and PCF (Policy Control Function). Specifically, this invention relates to methods for AMF, SMF, UPF, and PCF with NTN support functions to register with the Network Repository Function (NRF), methods for other NFs to search for AMF, SMF, UPF, and PCF with NTN support functions through the NRF, and methods for SMF and UPF with NTN support functions to perform the Association Setup procedure. Hereinafter, this disclosure relates to an apparatus and method for providing NTN support functions in a wireless communication system. Specifically, this disclosure describes technology for NFs in the 3GPP 5G system to efficiently provide NTN support functions in a wireless communication system.

Currently, 3GPP is working on standardization considering NTN for 5G systems. NTN provides characteristics that can reduce vulnerability to physical attacks and natural disasters by utilizing extensive service coverage capabilities and space/aviation platforms. Due to these characteristics, NTN can provide 5G services in a cost-effective manner in areas where terrestrial 5G networks are not serviced or are vulnerable. Additionally, NTN is expected to impact various fields including transportation, public safety, media and entertainment, eHealth, energy, agriculture, finance, and automotive through integrated terrestrial and non-terrestrial networks.

In 3GPP standardization work, NFs in the 5G system, such as AMF, SMF, UPF, and PCF, are defined to perform NTN support functions. However, in 3GPP Rel-16/17/18/19, there is a problem that methods for other NFs to search for AMF, SMF, PCF, and UPF with NTN support functions are not defined. Therefore, this invention proposes methods for AMF, SMF, PCF, and UPF with NTN support functions to register with the NRF and methods for SMF and UPF with NTN support functions to perform the Association Setup procedure, so that other NFs in the 5G system can find AMF, SMF, PCF, and UPF with NTN support functions.

Terms referring to signals, terms referring to channels, terms referring to control information, terms referring to network entities, terms referring to components of devices, etc., used in the following description are exemplified for convenience of explanation. Therefore, this disclosure is not limited to the terms described below, and other terms with equivalent technical meanings may be used.

Furthermore, although this disclosure explains various embodiments using terms used in some communication specifications (e.g., 3GPP (3rd Generation Partnership Project)), this is just an example for explanation. Various embodiments of this disclosure can be easily modified and applied to other communication systems.

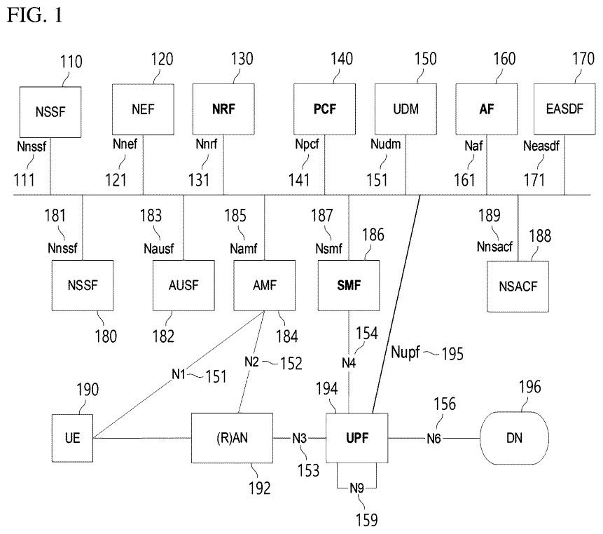

FIG. 1 illustrates a 5G system architecture with service-based architecture according to various embodiments of this disclosure.

Referring to FIG. 1, the Service Based Architecture (SBA) of the Third Generation Partnership Project (3GPP) Fifth Generation (5G) system architecture to which this disclosure applies is illustrated, which is currently under standardization work in Release-18 (Rel-18).

This architecture may include network function (Network Function, NF) entities in the upper layer such as Network Slice Selection Function (NSSF)(110), Network Exposure Function (NEF)(120), Network Repository Function (NRF)(130), Policy Control Function (PCF)(140), Unified Data Management (UDM)(150), Application Function (AF)(160), and Edge Application Server Discovery Function (EASDF)(170).

These upper layer NF entities can be interconnected through service-based interfaces such as Nnssf(111), Nnef(121), Nnrf(131), Npcf(141), Nudm(151), Naf(161), and Neasdf(171).

In the lower layer, NSSF(180), Authentication Server Function (AUSF)(182), Access and Mobility Management Function (AMF)(184), Session Management Function (SMF)(186), and Network Slice Admission Control Function (NSACF)(188) are located, which can be connected through interfaces Nnssf(181), Nausf(183), Namf(185), Nsmf(187), and Nnsacf(189), respectively.

User Equipment (UE)(190) is connected to AMF(184) through the N1 interface, and Radio Access Network ((R)AN)(192) can be connected to AMF(184) through the N2 interface and to User Plane Function (UPF)(194) through the N3 interface.

In particular, UPF(194) may be additionally connected to the SBA structure through an SBI interface called Nupf(195), in addition to the conventional N4 interface with SMF(186).

UPF(194) is connected to Data Network (DN)(196) through the N6 interface and can be connected to other UPFs through the N9 interface.

Through this structure, flexible service-based communication between network functions in the 5G system is possible.

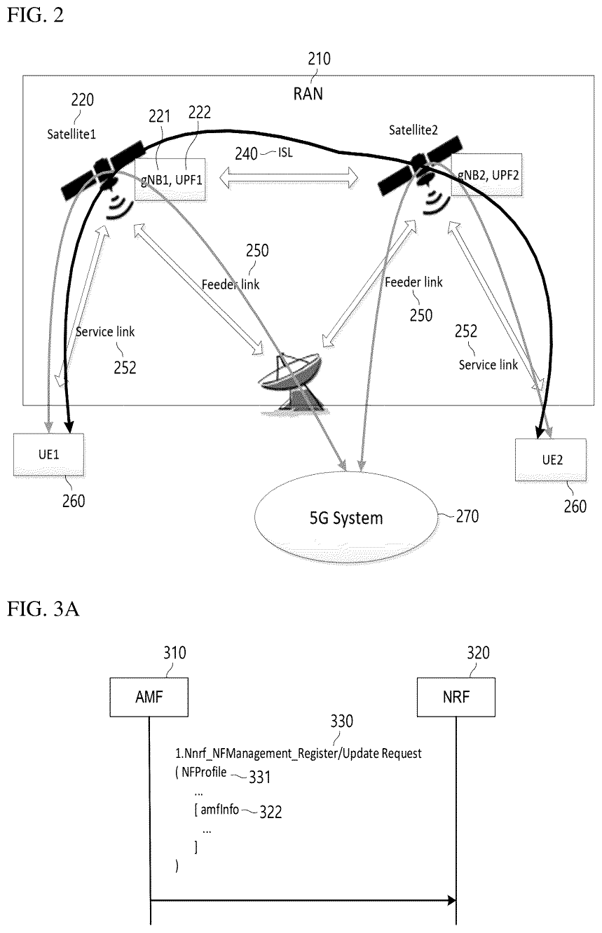

FIG. 2 illustrates a 5G system architecture supporting Satellite Access RAN according to various embodiments of this disclosure.

Referring to FIG. 2, the 3GPP 5G system architecture supporting Satellite Access Radio Access Network (RAN) structure to which this disclosure applies is illustrated, which is currently under standardization work in Rel-19.

Within the RAN(210), Satellite1(220) and Satellite2(230) can be included, and Satellite1 can have next Generation Node B1 (gNB1)(221) and User Plane Function 1(UPF1)(222) mounted on it.

An Inter-Satellite Link (ISL)(240) can be formed between the two satellites.

Each satellite can be connected to ground antennas through Feeder link(250), and User Equipment(UE1)(260) and UE2(262) can communicate with their respective satellites through Service link(252).

The 5G System(270) can perform communication by connecting with satellites through the Feeder link.

Meanwhile, the 3GPP 5G system architecture has defined a Network Repository Function(NRF) component to provide service discovery between individual Network Functions(NF). An NF registers its own service functions with the NRF so that other NFs can search for service functions.

Through this structure, satellite-based Non-Terrestrial Network(NTN) can be integrated into the 5G system to provide services.

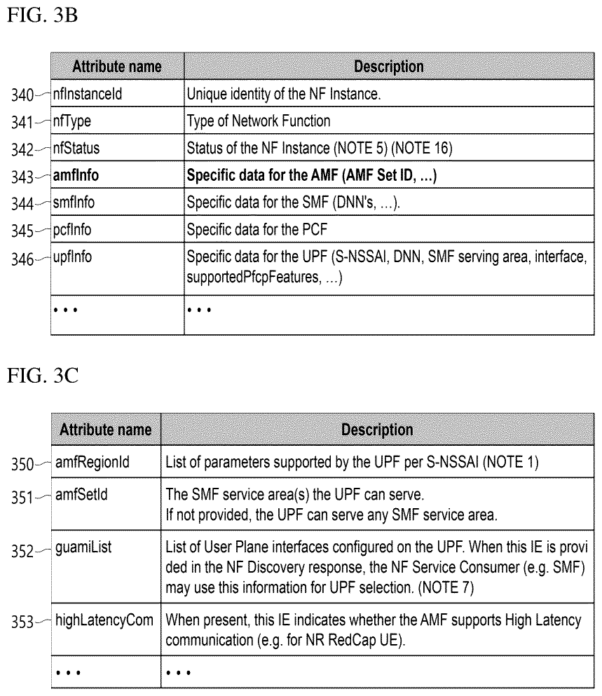

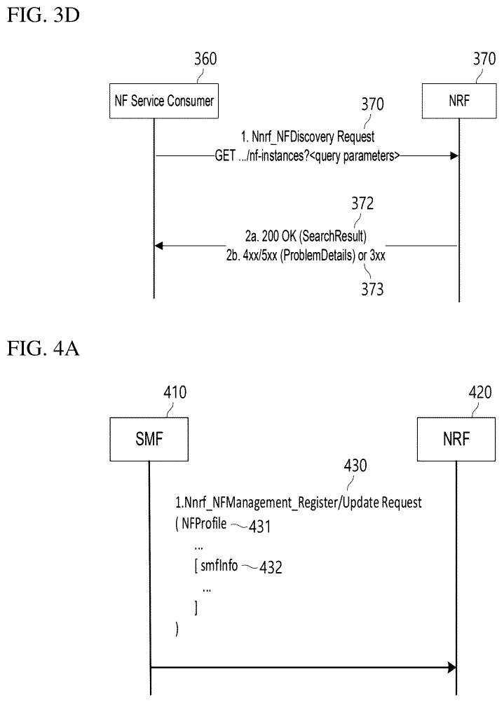

FIG. 3a illustrates a procedure for AMF to register with NRF according to various embodiments of this disclosure.

Referring to FIG. 3a, a procedure for Access and Mobility Management Function(AMF)(310) to register its own functions with Network Repository Function(NRF)(320) is illustrated. AMF can transmit a registration message to the NRF including NFProfile(331) and amfInfo(332) information in the NFRegister or NFUpdate operation(330) of the Nnrf_NFManagement service.

FIG. 3b illustrates NFProfile information that AMF registers with NRF according to an embodiment of this disclosure.

Referring to FIG. 3b, the main attributes of NFProfile are included. Specifically, it may include the unique identifier of the NF instance(nfInstanceId)(340), network function type(nfType)(341), status of the NF instance(nfStatus)(342), AMF specific data(amfInfo)(343), SMF specific data(smfInfo)(344), PCF specific data(pcfInfo)(345), and UPF specific data(upfInfo)(346).

FIG. 3c illustrates amfInfo information that AMF registers with NRF according to an embodiment of this disclosure.

Referring to FIG. 3c, FIG. 3c represents the internal attributes of amfInfo, which may include information such as AMF Region Identifier(amfRegionId)(350), AMF Set Identifier(amfSetId)(351), GUAMI List(guamiList)(352), and High Latency Communication Support(highLatencyCom)(353).

FIG. 3d illustrates a procedure for NF to search for AMF from NRF according to various embodiments of this disclosure. Specifically, FIG. 3d illustrates a procedure for NF Service Consumer(360) to search for AMF with specific functions from NRF(370).

Referring to FIG. 3d, the NF Service Consumer can transmit query-parameters to the NRF through Nnrf_NFDiscovery Request(371) to find AMF with specific functions. In response, the NRF can transmit search results(SearchResult)(372) or error information(ProblemDetails)(373). According to an embodiment, the query-parameters can be configured in a form such as “NFType=AMF&highLatencyCom=true”.

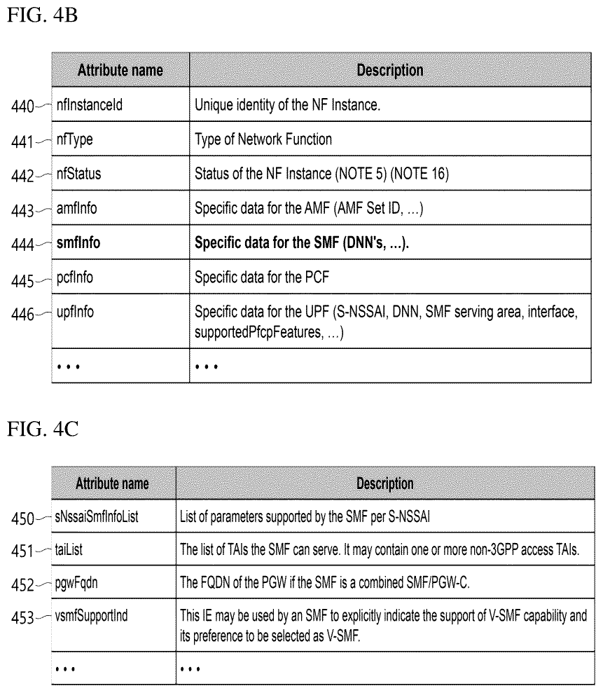

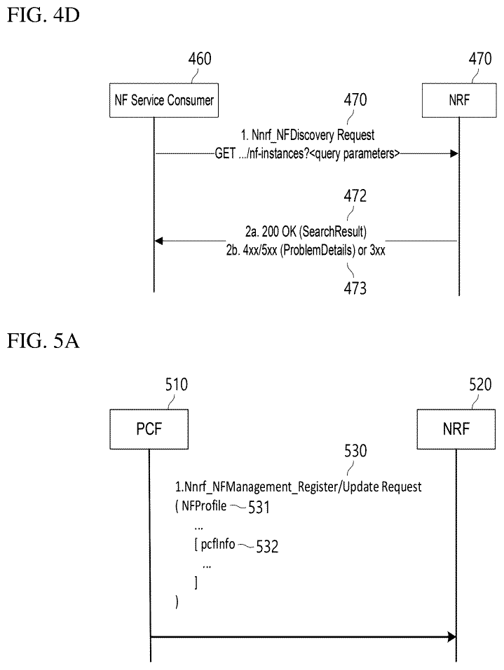

FIG. 4a illustrates a procedure for SMF to register with NRF according to an embodiment of this disclosure. Specifically, FIG. 4a illustrates a procedure for Session Management Function(SMF)(410) to register its own functions with Network Repository Function(NRF)(420).

Referring to FIG. 4a, SMF can transmit a registration message to the NRF including NFProfile(431) of FIG. 4b and smfInfo(432) information of FIG. 4c in the NFRegister or NFUpdate operation(430) of the Nnrf_NFManagement service.

Through this procedure, SMF can register its function information with the NRF to enable other network functions to search for it.

FIG. 4b illustrates NFProfile information that SMF registers with NRF according to various embodiments of this disclosure. Specifically, FIG. 4b includes the main attributes of NFProfile.

Referring to FIG. 4b, FIG. 4b may include the unique identifier of the NF instance(nfInstanceId)(440), network function type(nfType)(441), status of the NF instance(nfStatus)(442), AMF specific data(amfInfo)(443), SMF specific data(smfInfo)(444), PCF specific data(pcfInfo)(445), and UPF specific data(upfInfo)(446).

FIG. 4c illustrates smfInfo information that SMF registers with NRF according to various embodiments of this disclosure.

Referring to FIG. 4c, FIG. 4c represents the internal attributes of smfInfo, which may include information such s list of SMF support parameters per S-NSSAI(sNssaiSmfInfoList)(450), TAI list(taiList)(451), FQDN of PGW(pgwFqdn)(452), and visiting SMF support indicator(vsmfSupportInd)(453).

FIG. 4d illustrates a procedure for NF to search for SMF from NRF according to various embodiments of this disclosure.

Referring to FIG. 4d, FIG. 4d illustrates a procedure for NF Service Consumer(460) to search for SMF with specific functions from NRF(470). The NF Service Consumer can transmit query-parameters to the NRF through Nnrf NFDiscovery Request(471) to find SMF with specific functions. In response, the NRF can transmit search results(SearchResult)(472) or error information(ProblemDetails)(473). According to an embodiment, the query-parameters can be configured in a form such as “NFType=SMF&vsmfSupportInd=true”.

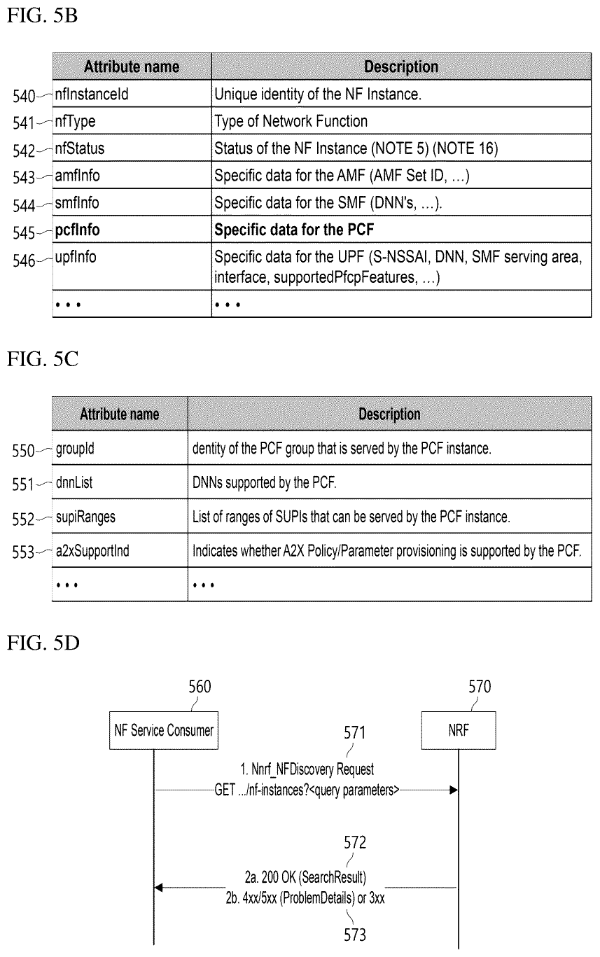

FIG. 5a illustrates a procedure for PCF to register with NRF according to an embodiment of this disclosure.

Referring to FIG. 5a, a procedure for Policy Control Function(PCF)(510) to register its own functions with Network Repository Function(NRF)(520) is illustrated.

PCF can transmit a registration message to the NRF including NFProfile(531) of FIG. 5b and pcfInfo(532) information of FIG. 5c in the NFRegister or NFUpdate operation(530) of the Nnrf NFManagement service.

Through this procedure, PCF can register its function information with the NRF to enable other network functions to search for it.

FIG. 5b illustrates NFProfile information that PCF registers with NRF according to an embodiment of this disclosure.

Referring to FIG. 5b, FIG. 5b includes the main attributes of NFProfile. Specifically, it may include the unique identifier of the NF instance(nfInstanceld)(540), network function type(nfType)(541), status of the NF instance(nfStatus)(542), AMF specific data(amfInfo)(543),

SMF specific data(smfInfo)(544), PCF specific data(pcfInfo)(545), and UPF specific data(upfInfo)(546).

FIG. 5c illustrates pcfInfo information that PCF registers with NRF according to an embodiment of this disclosure.

Referring to FIG. 5c, FIG. 5c represents the internal attributes of pcfInfo, which may include information such as PCF group identifier(groupId)(550), DNN list(dnnList)(551), SUPI range list(supiRanges)(552), and A2X policy/parameter provisioning support indicator(a2xSupportInd)(553).

FIG. 5d illustrates a procedure for NF to search for PCF from NRF according to an embodiment of this disclosure.

Referring to FIG. 5d, FIG. 5d illustrates a procedure for NF Service Consumer(560) to search for PCF with specific functions from NRF(570). The NF Service Consumer can transmit query-parameters to the NRF through Nnrf_NFDiscovery Request(571) to find PCF with specific functions. In response, the NRF can transmit search results(SearchResult)(572) or error information(ProblemDetails)(573). According to an embodiment, the query-parameters can be configured in a form such as “NFType=PCF&a2xSupportInd=true”.

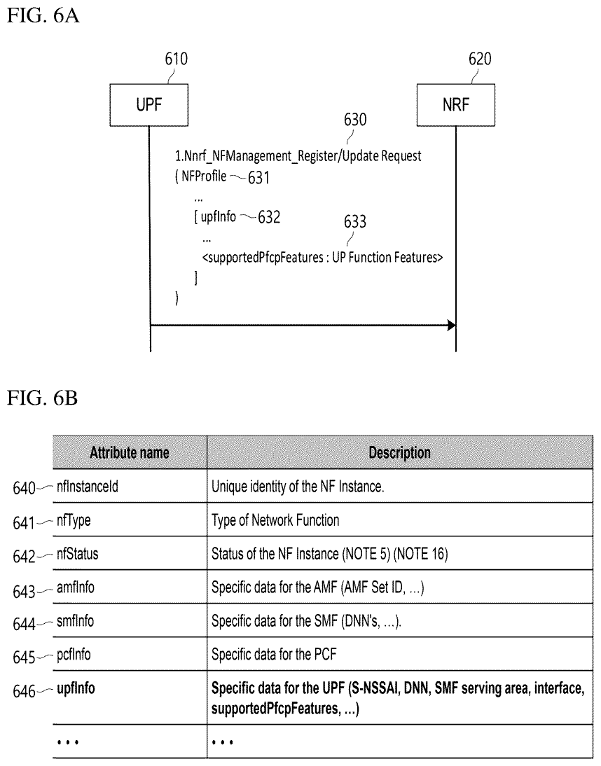

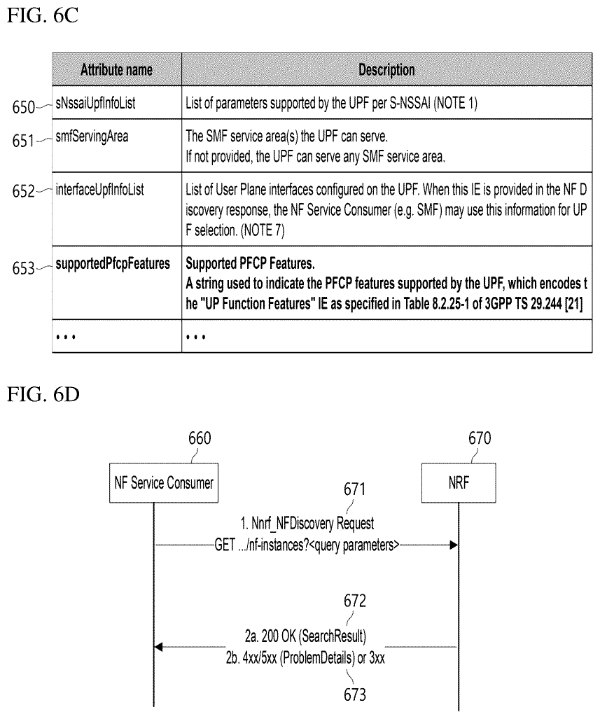

FIG. 6a illustrates a procedure for UPF to register with NRF according to various embodiments of this disclosure.

Referring to FIG. 6a, a procedure for User Plane Function(UPF)(610) to register its own functions with Network Repository Function(NRF)(620) is illustrated.

UPF can transmit a registration message to the NRF including NFProfile(631) of FIG. 6b and upfInfo(632) information of FIG. 6c in the NFRegister or NFUpdate operation(630) of the Nnrf_NFManagement service. In particular, the internal attribute of upfInfo, supportedPfcpFeatures(633), may refer to UP Function Features defined in 3GPP TS 29.244 Table 8.2.25-1.

FIG. 6b illustrates NFProfile information that UPF registers with NRF according to an embodiment of this disclosure.

Referring to FIG. 6b, FIG. 6b includes the main attributes of NFProfile. Specifically, it may include the unique identifier of the NF instance(nfInstanceId)(640), network function type(nfType)(641), status of the NF instance(nfStatus)(642), AMF specific data(amfInfo)(643), SMF specific data(smfInfo)(644), PCF specific data(pcfInfo)(645), and UPF specific data(upfInfo)(646).

FIG. 6c illustrates upfInfo information that UPF registers with NRF according to various embodiments of this disclosure.

Referring to FIG. 6c, FIG. 6c represents the internal attributes of upfInfo, which may include information such as list of UPF support parameters per S-NSSAI(sNssaiUpfInfoList)(650), SMF serving area(smfServingArea)(651), UPF interface list(interfaceUpfInfoList)(652), and supported PFCP features(supportedPfcpFeatures)(653).

FIG. 6d illustrates a procedure for NF to search for UPF from NRF according to various embodiments of this disclosure.

Referring to FIG. 6d, FIG. 6d illustrates a procedure for NF Service Consumer(660) to search for UPF with specific functions from NRF(670). The NF Service Consumer can transmit query-parameters to the NRF through Nnrf_NFDiscovery Request(671) to find UPF with specific functions. In response, the NRF can transmit search results(SearchResult)(672) or error information(ProblemDetails)(673). According to an embodiment, the query-parameters can be configured in a form such as “NFType=UPF&supportedPfcpFeatures&BUCP=1”.

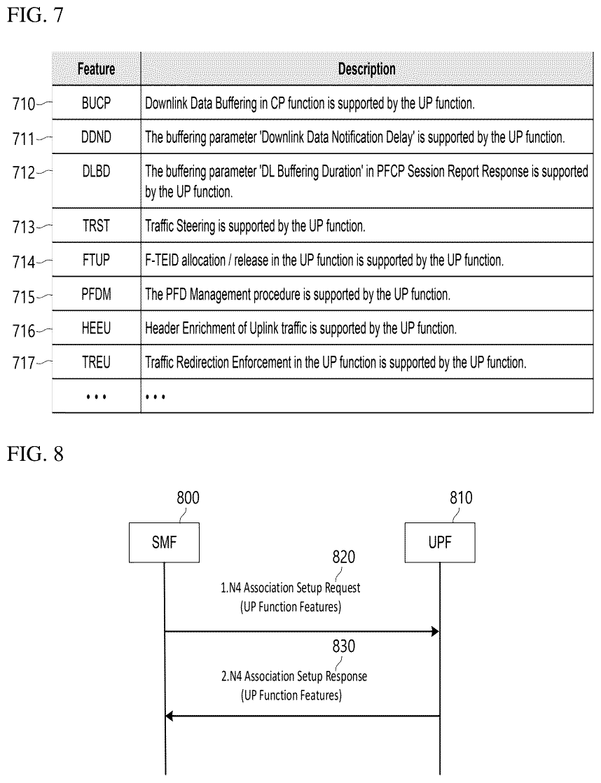

FIG. 7 illustrates UP Function Features according to various embodiments of this disclosure.

Referring to FIG. 7, FIG. 7 shows each function and description of UP Function Features.

Specifically, BUCP(710) indicates that downlink data buffering in the control plane function is supported by the UP function. DDND(711) indicates that the downlink data notification delay buffering parameter is supported by the UP function. DLBD(712) indicates that the downlink buffering duration parameter in PFCP Session Report Response is supported by the UP function. TRST(713) indicates that traffic steering is supported by the UP function. FTUP(714) indicates that F-TEID allocation/release in the UP function is supported by the UP function. PFDM(715) indicates that the PFD management procedure is supported by the UP function. HEEU(716) indicates that header enrichment of uplink traffic is supported by the UP function. TREU(717) indicates that traffic redirection enforcement in the UP function is supported by the UP function.

These functions represent the capabilities supported by the UPF and can be included as the supportedPfcpFeatures attribute when registered with the NRF.

FIG. 8 illustrates an Association Setup procedure between SMF and UPF according to various embodiments of this disclosure.

Referring to FIG. 8, a procedure for establishing an Association connection between Session Management Function(SMF)(800) and User Plane Function(UPF)(810) connected via the N4 interface is illustrated.

SMF can transmit the N4 Association Setup Request message(820) including parameters requesting UP Function Features from UPF to check the UP Function Features of UPF.

In response, UPF can transmit the N4 Association Setup Response message(830) to SMF including the UP Function Features supported by the UPF.

Through this procedure, SMF can verify the functions supported by UPF and utilize them for subsequent session management.

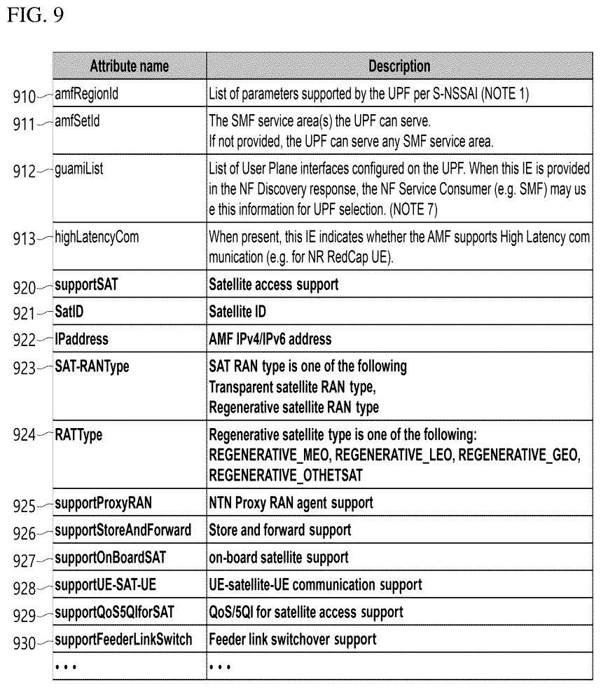

FIG. 9 illustrates access and mobility management function information including NTN support functions according to an embodiment of this disclosure.

Referring to FIG. 9, FIG. 9 illustrates access and mobility management function information(amfInfo) including NTN support functions that AMF of a 5G system with NTN support capabilities registers with the NRF.

The access and mobility management function information may include existing AMF attributes such as AMF Region Identifier(amfRegionId)(910), AMF Set Identifier(amfSetId)(911), GUAMI List(guamiList)(912), and High Latency Communication Support(highLatencyCom)(913). In particular, major attributes related to NTN support can be added, such as Satellite Access Support(supportSAT)(920), Satellite ID(SatID)(921), and AMF IP address(AMF IPv4/IPv6 address, IPaddress)(922).

Satellite RAN Type(SAT-RANType)(923) can specify either Transparent satellite RAN type or Regenerative satellite RAN type. For Regenerative Satellite Type(RATType)(924), one of medium earth orbit regenerative satellite(REGENERATIVE_MEO), low earth orbit regenerative satellite(REGENERATIVE_LEO), earth geostationary orbit regenerative satellite(REGENERATIVE_GEO), or other regenerative satellite(REGENERATIVE_OTHERSAT) can be selected.

It may also include attributes indicating support for additional functions such as NTN Proxy RAN Agent Support(supportProxyRAN)(925), Store and Forward Support(supportStoreAndForward)(926), On-board Satellite Support(supportOnBoardSAT)(927), UE-Satellite-UE Communication Support(supportUE-SAT-UE)(928), QoS/5QI for Satellite Access Support(supportQoS5QIforSAT)(929), and Feeder Link Switchover Support(supportFeederLinkSwitch)(930).

Through these extended access and mobility management function information attributes, AMF registers its NTN-related functions with the NRF so that other network functions can search for and utilize them.

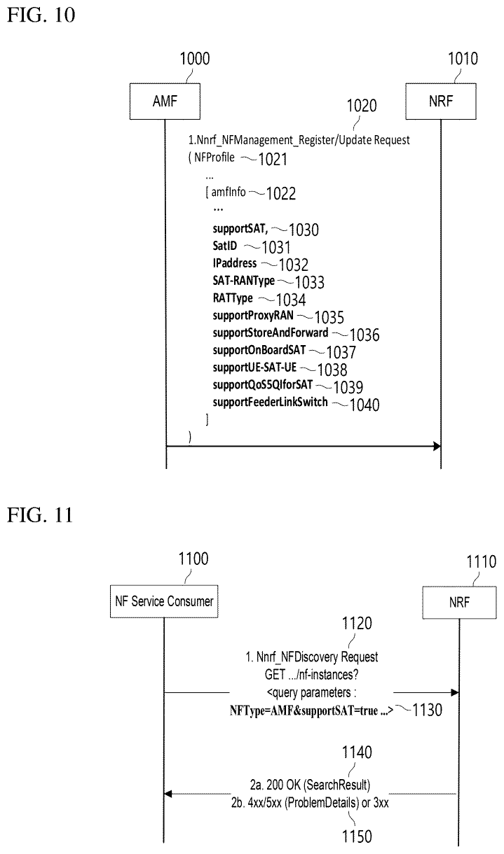

FIG. 10 illustrates a procedure for AMF including NTN support functions to register with NRF according to an embodiment of this disclosure. Specifically, FIG. 10 illustrates a procedure for Access and Mobility Management Function(AMF)(1000) including NTN support functions of 5G system to register with Network Repository Function(NRF)(1010).

Referring to FIG. 10, AMF can transmit NFProfile(1021) including access and mobility management function information(amfInfo)(1022) to the NRF through the network function management registration/update request(Nnrf_NFManagement_Register/Update Request) message(1020). In particular, the following information related to NTN support is included:

Basic satellite access information such as Satellite Access Support(supportSAT)(1030), Satellite ID(SatID)(1031), AMF IP address(IPaddress)(1032), Satellite RAN Type(SAT-RANType)(1033), and Regenerative Satellite Type(RATType)(1034) can be included.

Additionally, it can transmit information indicating support for additional functions such as NTN Proxy RAN Agent Support(supportProxyRAN)(1035), Store and Forward Support(supportStoreAndForward)(1036), On-board Satellite Support(supportOnBoardSAT)(1037), UE-Satellite-UE Communication Support(supportUE-SAT-UE)(1038), QoS/5QI for Satellite Access Support(supportQoS5QIforSAT)(1039), and Feeder Link Switchover Support(supportFeederLinkSwitch)(1040).

Through this registration procedure, AMF registers its NTN-related functions that it supports with the NRF, enabling other network functions to search for and utilize them.

FIG. 11 illustrates a procedure for NF to search for AMF including NTN support functions from NRF according to an embodiment of this disclosure. Specifically, FIG. 11 illustrates a procedure for Network Function Service Consumer(NF Service Consumer)(1100) of 5G system to search for AMF including NTN support functions from Network Repository Function(NRF)(1110).

Referring to FIG. 11, the NF Service Consumer can transmit query parameters(1130) to the NRF through the network function discovery request(Nnrf_NFDiscovery Request) message(1120). According to an embodiment, the query parameters can be configured by specifying the AMF type and satellite access support, such as “NFType=AMF&supportSAT=true”.

In response, the NRF can transmit search results(SearchResult)(1140) or error information(ProblemDetails)(1150). The search results can be delivered as a ‘200 OK’ response when successful, or as ‘4xx/5xx’ error codes or ‘3xx’ redirection responses when unsuccessful.

Through this search procedure, the NF Service Consumer can identify AMF with NTN support functions and utilize the corresponding services.

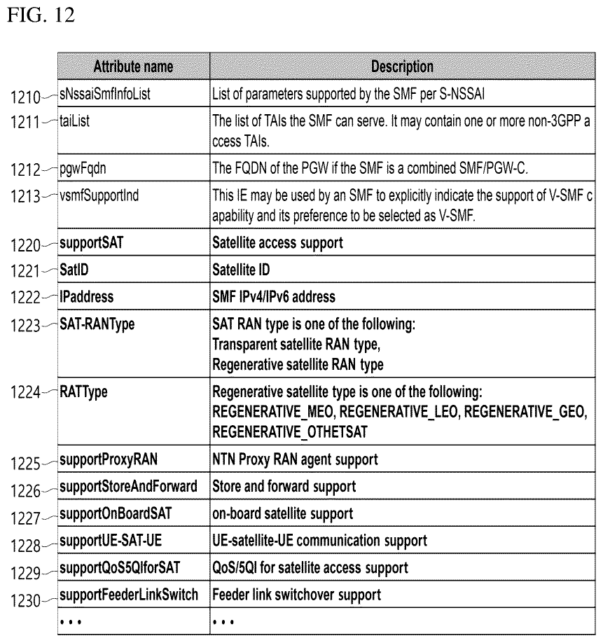

FIG. 12 illustrates session management function information(smfInfo) including NTN support functions according to an embodiment of this disclosure. Specifically, FIG. 12 illustrates session management function information(smfInfo) including NTN support functions that is registered with the NRF.

Referring to FIG. 12, the session management function information may include existing SMF attributes such as list of SMF information per S-NSSAI(sNssaiSmfInfoList)(1210), TAI list(taiList)(1211), FQDN information of PGW(pgwFqdn)(1212), and visiting SMF support indicator(vsmfSupportInd)(1213).

In particular, the following information related to NTN support can be included: basic satellite access information such as Satellite Access Support(supportSAT)(1220), Satellite ID(SatID)(1221), SMF IP address(SMF IPv4/IPv6 address, IPaddress)(1222), Satellite RAN Type(SAT-RANType)(1223), and Regenerative Satellite Type(RATType)(1224).

Additionally, it may include information indicating support for additional functions such as NTN Proxy RAN Agent Support(supportProxyRAN)(1225), Store and Forward Support(supportStoreAndForward)(1226), On-board Satellite Support(supportOnBoardSAT)(1227), UE-Satellite-UE Communication Support(supportUE-SAT-UE)(1228), QoS/5QI for Satellite Access Support(supportQoS5QIforSAT)(1229), and Feeder Link Switchover Support(supportFeederLinkSwitch)(1230).

Through these extended session management function information attributes, SMF registers its NTN-related functions with the NRF so that other network functions can search for and utilize them.

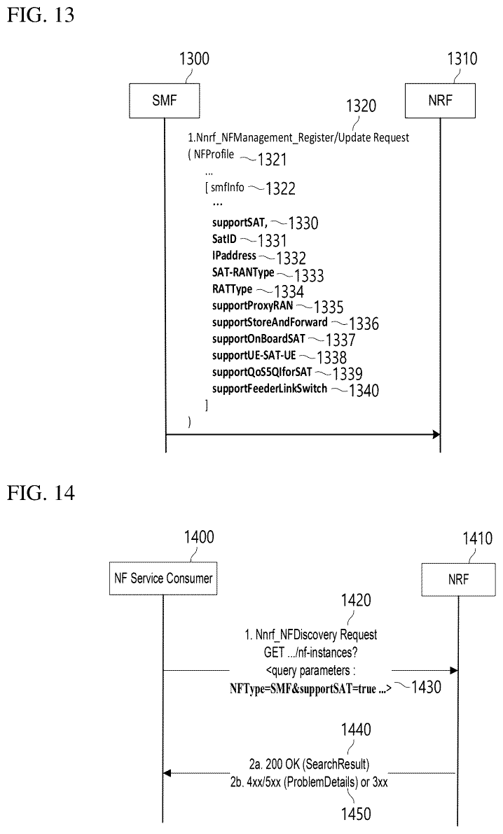

FIG. 13 illustrates a procedure for SMF including NTN support functions to register with NRF according to an embodiment of this disclosure. Specifically, FIG. 13 illustrates a procedure for Session Management Function(SMF)(1300) including NTN support functions of 5G system to register with Network Repository Function(NRF)(1310).

Referring to FIG. 13, SMF can transmit NFProfile(1321) including session management function information(smfInfo)(1322) to the NRF through the network function management registration/update request(Nnrf_NFManagement_Register/Update Request) message(1320). In particular, the following information related to NTN support is included:

Basic satellite access information such as Satellite Access Support(supportSAT)(1330), Satellite ID(SatID)(1331), SMF IP address(IPaddress)(1332), Satellite RAN Type(SAT-RANType)(1333), and Regenerative Satellite Type(RATType)(1334) can be included.

Additionally, it can transmit information indicating support for additional functions such as NTN Proxy RAN Agent Support(supportProxyRAN)(1335), Store and Forward Support(supportStoreAndForward)(1336), On-board Satellite Support(supportOnBoardSAT)(1337), UE-Satellite-UE Communication Support(supportUE-SAT-UE)(1338), QoS/5QI for Satellite Access Support(supportQoS5QIforSAT)(1339), and Feeder Link Switchover Support(supportFeederLinkSwitch)(1340).

Through this registration procedure, SMF registers its NTN-related functions that it supports with the NRF, enabling other network functions to search for and utilize them.

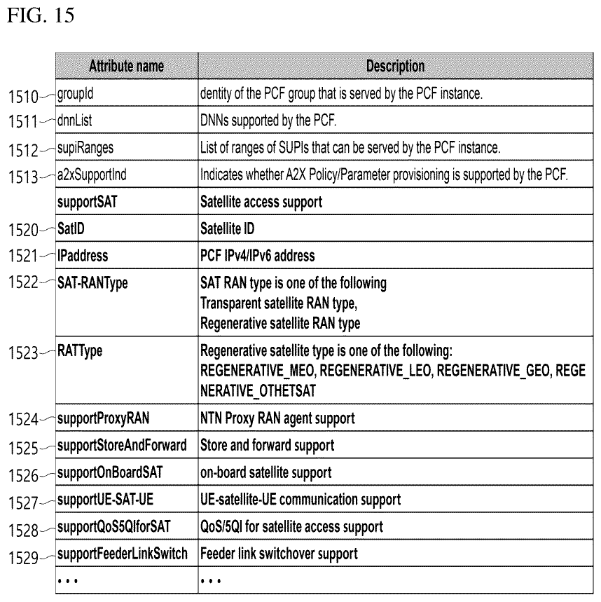

FIG. 14 illustrates a procedure for NF to search for SMF including NTN support functions from NRF according to an embodiment of this disclosure. Specifically, FIG. 14 illustrates a procedure for Network Function Service Consumer(NF Service Consumer)(1400) of 5G system to search for SMF including NTN support functions from Network Repository Function(NRF)(1410).

Referring to FIG. 14, the NF Service Consumer can transmit query parameters(1430) to the NRF through the network function discovery request(Nnrf_NFDiscovery Request) message(1420). According to an embodiment, the query parameters can be configured by specifying the SMF type and satellite access support, such as “NFType=SMF&supportSAT=true”.

In response, the NRF can transmit search results(SearchResult)(1440) or error information(ProblemDetails)(1450). The search results can be delivered as a ‘200 OK’ response when successful, or as ‘4xx/5xx’ error codes or ‘3xx’ redirection responses when unsuccessful.

Through this search procedure, the NF Service Consumer can identify SMF with NTN support functions and utilize the corresponding services.

FIG. 15 illustrates policy control function information(pcfInfo) including NTN support functions according to an embodiment of this disclosure. Specifically, FIG. 15 illustrates policy control function information(pcfInfo) including NTN support functions that is registered with the NRF.

Referring to FIG. 15, the policy control function information(pcfInfo) may include existing PCF attributes such as PCF group identifier(groupId)(1510), DNN list(dnnList)(1511), SUPI range list(supiRanges)(1512), and A2X provisioning support indicator(a2xSupportInd)(1513).

In particular, the following information related to NTN support can be included: basic satellite access information such as Satellite Access Support(supportSAT)(1520), Satellite ID(SatID)(1521), PCF IP address(PCF IPv4/IPv6 address, IPaddress)(1522), Satellite RAN Type(SAT-RANType)(1523), and Regenerative Satellite Type(RATType)(1524).

Additionally, it may include information indicating support for additional functions such as NTN Proxy RAN Agent Support(supportProxyRAN)(1525), Store and Forward Support(supportStoreAndForward)(1526), On-board Satellite Support(supportOnBoardSAT)(1527), UE-Satellite-UE Communication Support(supportUE-SAT-UE)(1528), QoS/5QI for Satellite Access Support(supportQoS5QIforSAT)(1529), and Feeder Link Switchover Support(supportFeederLinkSwitch)(1530).

Through these extended policy control function information attributes, PCF registers its NTN-related functions with the NRF so that other network functions can search for and utilize them.

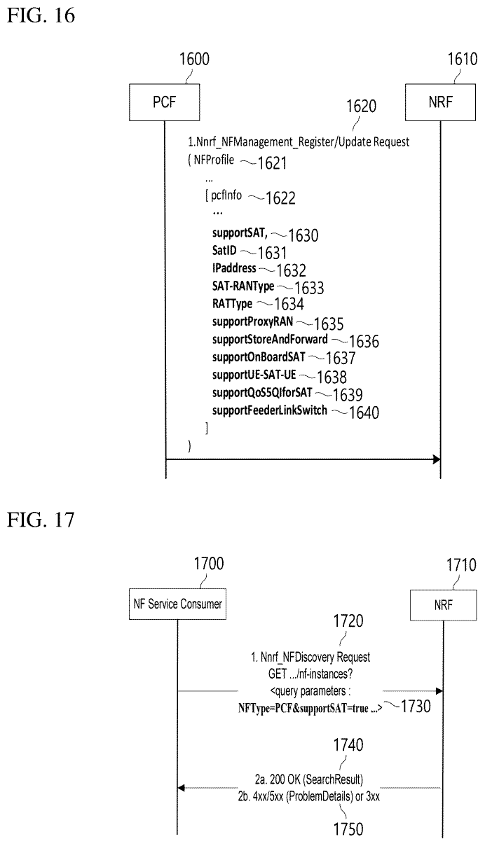

FIG. 16 illustrates a procedure for PCF including NTN support functions to register with NRF according to an embodiment of this disclosure. Specifically, FIG. 16 illustrates a procedure for Policy Control Function(PCF)(1600) including NTN support functions of 5G system to register with Network Repository Function(NRF)(1610).

Referring to FIG. 16, PCF can transmit NFProfile(1621) including policy control function information(pcfInfo)(1622) to the NRF through the network function management registration/update request(Nnrf_NFManagement_Register/Update Request) message(1620). In particular, the following information related to NTN support can be included:

Basic satellite access information such as Satellite Access Support(supportSAT)(1630), Satellite ID(SatID)(1631), PCF IP address(IPaddress)(1632), Satellite RAN Type(SAT-RANType)(1633), and Regenerative Satellite Type(RATType)(1634) can be included.

Additionally, it can transmit information indicating support for additional functions such as NTN Proxy RAN Agent Support(supportProxyRAN)(1635), Store and Forward Support(supportStoreAndForward)(1636), On-board Satellite Support(supportOnBoardSAT)(1637), UE-Satellite-UE Communication Support(supportUE-SAT-UE)(1638), QoS/5QI for Satellite Access Support(supportQoS5QIforSAT)(1639), and Feeder Link Switchover Support(supportFeederLinkSwitch)(1640).

Through this registration procedure, PCF registers its NTN-related functions that it supports with the NRF, enabling other network functions to search for and utilize them.

FIG. 17 illustrates a procedure for NF to search for PCF including NTN support functions from NRF according to an embodiment of this disclosure. Specifically, FIG. 17 illustrates a procedure for Network Function Service Consumer(NF Service Consumer)(1700) of 5G system to search for PCF including NTN support functions from Network Repository Function(NRF)(1710).

Referring to FIG. 17, the NF Service Consumer can transmit query parameters(1730) to the NRF through the network function discovery request(Nnrf_NFDiscovery Request) message(1720). According to an embodiment, the query parameters can be configured by specifying the PCF type and satellite access support, such as “NFType=PCF&supportSAT=true”.

In response, the NRF can transmit search results(SearchResult)(1740) or error information(ProblemDetails)(1750). The search results can be delivered as a ‘200 OK’ response when successful, or as ‘4xx/5xx’ error codes or ‘3xx’ redirection responses when unsuccessful.

Through this search procedure, the NF Service Consumer can identify PCF with NTN support functions and utilize the corresponding services.

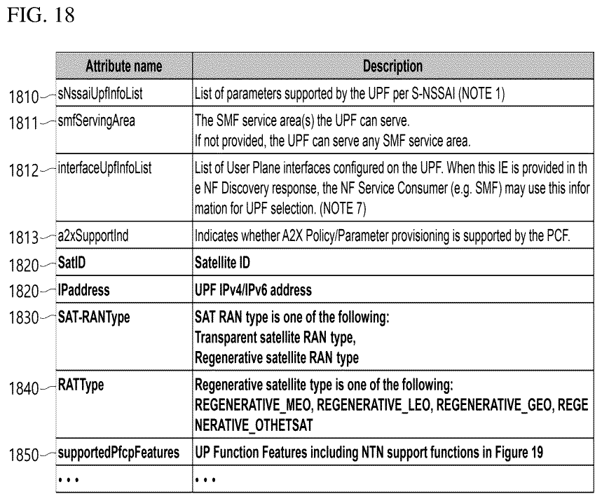

FIG. 18 illustrates user plane function information(upfInfo) including NTN support functions according to an embodiment of this disclosure. Specifically, FIG. 18 illustrates user plane function information(upfInfo) including NTN support functions that is registered with the NRF.

Referring to FIG. 18, the user plane function information(upfInfo) may include existing UPF attributes such as list of UPF information per S-NSSAI(sNssaiUpfInfoList)(1810), SMF serving area(smfServingArea)(1811), UPF interface information list(interfaceUpfInfoList)(1812), and A2X policy/parameter provisioning support indicator(a2xSupportInd)(1813).

According to an embodiment, the user plane function information(upfInfo) includes the following information related to NTN support: Satellite ID(SatID)(1820), UPF IP address(UPF IPv4/IPv6 address, IPaddress)(1830), and Satellite RAN Type(SAT-RANType)(1840). The Satellite RAN Type can be specified as either Transparent satellite RAN type or Regenerative satellite RAN type.

For regenerative satellites, the Regenerative Satellite Type(RATType) can be specified as one of medium earth orbit regenerative satellite(REGENERATIVE_MEO), low earth orbit regenerative satellite(REGENERATIVE_LEO), geostationary earth orbit regenerative satellite(REGENERATIVE_GEO), or other regenerative satellite(REGENERATIVE_OTHERSAT).

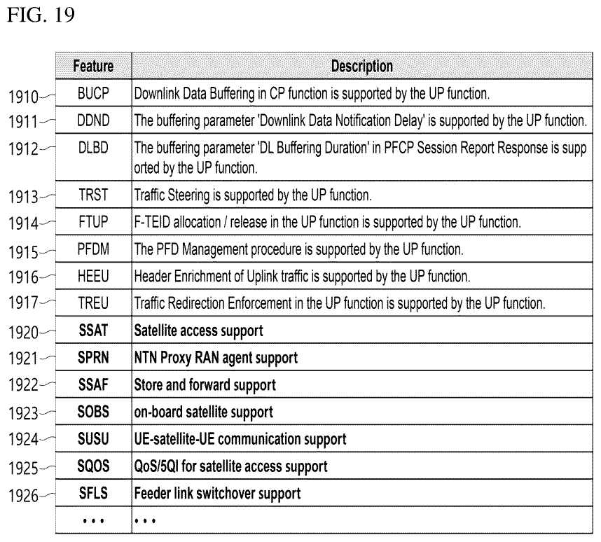

Additionally, the user plane function information (upfInfo) can specify UP Function Features including NTN support functions defined in FIG. 19 through supported PFCP features(supportedPfcpFeatures)(1850).

Through these extended user plane function information attributes, UPF registers its NTN-related functions with the NRF so that other network functions can search for and utilize them.

FIG. 19 illustrates UP Function Features including NTN support Features for UPF of 5G system to provide UP Function Features information to NRF or SMF according to an embodiment of this disclosure. Specifically, FIG. 19 illustrates the form of existing UP Function Features with added NTN support Features.

Referring to FIG. 19, UP Function Features may include existing functions such as downlink data buffering in the control plane(BUCP)(1910), downlink data notification delay(DDND)(1911), downlink buffering duration in PFCP session report response(DLBD)(1912), traffic steering(TRST)(1913), F-TEID allocation/release(FTUP)(1914), PFD management procedure(PFDM)(1915), header enrichment of uplink traffic(HEEU)(1916), and traffic redirection enforcement(TREU)(1917).

According to an embodiment, UP Function Features includes the following Features related to NTN support: Satellite Access Support(SSAT)(1920), NTN Proxy RAN Agent Support(SPRN)(1921), Store and Forward Support(SSAF)(1922), On-board Satellite Support(SOBS)(1923), UE-Satellite-UE Communication Support(SUSU)(1924), QoS/5QI for Satellite Access Support(SQOS)(1925), and Feeder Link Switchover Support(SFLS)(1926).

Through these extended UP Function Features, UPF provides its NTN-related functions to NRF or SMF, enabling efficient network function operation.

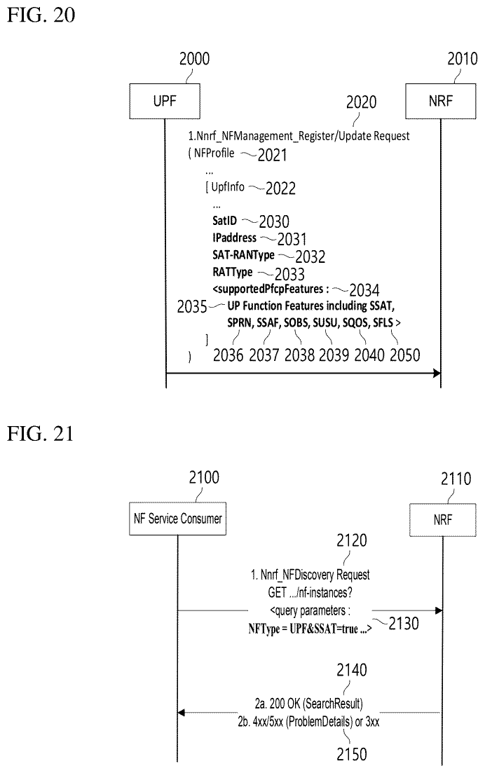

FIG. 20 illustrates a procedure for user plane function(UPF) including NTN support Features of 5G system to register with network repository function(NRF) according to an embodiment of this disclosure. Specifically, FIG. 20 illustrates the process of UPF registering UP Function Features including NTN support Features with the NRF.

Referring to FIG. 20, UPF(2000) can transmit NFProfile(2021) including user plane function information(upfInfo)(2022) to NRF(2010) through the network function management registration/update request(Nnrf_NFManagement_Register/Update Request) message(2020).

According to an embodiment, the user plane function information(upfInfo) includes the following information related to NTN support: basic satellite access information such as Satellite ID(SatID)(2030), UPF IP address(IPaddress)(2031), Satellite RAN Type(SAT-RANType)(2032), and Regenerative Satellite Type(RATType)(2033).

The user plane function information(upfInfo) can include UP Function Features through supported PFCP features(supportedPfcpFeatures)(2034), which may include Satellite Access Support(SSAT)(2035), NTN Proxy RAN Agent Support(SPRN)(2036), Store and Forward Support(SSAF)(2037), On-board Satellite Support(SOBS)(2038), UE-Satellite-UE Communication Support(SUSU)(2039), QoS/5QI for Satellite Access Support(SQOS)(2040), and Feeder Link Switchover Support(SFLS)(2050).

Through this registration procedure, UPF registers its NTN-related functions that it supports with the NRF, enabling other network functions to search for and utilize them.

FIG. 21 illustrates a procedure for NF of 5G system to search for UPF including NTN support Features from NRF according to an embodiment of this disclosure. Specifically, FIG. 21 illustrates the process of a network function service consumer searching for UPF including NTN support Features.

Referring to FIG. 21, Network Function Service Consumer(NF Service Consumer)(2100) can transmit query parameters(2130) to Network Repository Function(NRF)(2110) through the network function discovery request(Nnrf_NFDiscovery Request) message(2120). According to an embodiment, the query parameters can be configured by specifying the UPF type and satellite access support, such as “NFType=UPF&SSAT-true”.

In response, the NRF can transmit search results(SearchResult)(2140) or error information(ProblemDetails)(2150). The search results can be delivered as a ‘200 OK’ response when successful, or as ‘4xx/5xx’ error codes or ‘3xx’ redirection responses when unsuccessful.

Through this search procedure, the network function service consumer can identify UPF with NTN support Features and utilize the corresponding services.

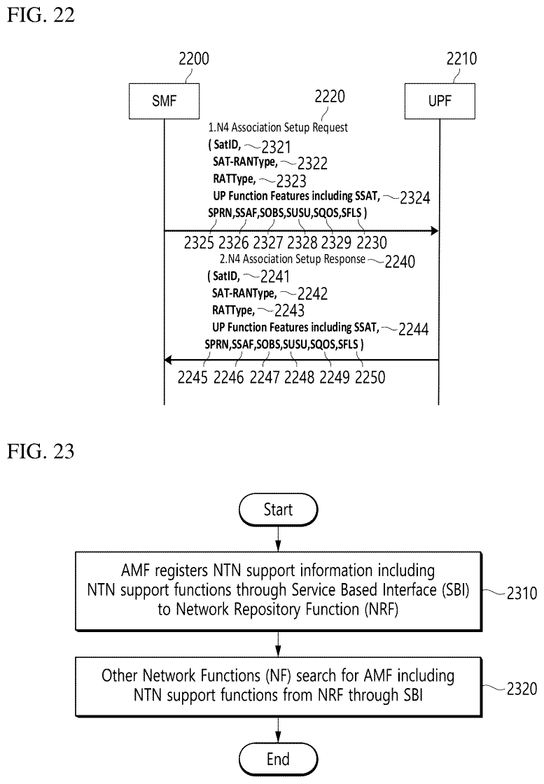

FIG. 22 illustrates a procedure for UPF to provide UP Function Features including NTN support Features to SMF in the Association Setup procedure of SMF and UPF of 5G system according to an embodiment of this disclosure. Specifically, FIG. 22 illustrates the Association Setup procedure between SMF and UPF through the N4 interface. Referring to FIG. 22, Session Management Function(SMF)(2200) can transmit the following information to User Plane Function(UPF)(2210) through the N4 Association Setup Request message(2220): Satellite ID(SatID)(2321), Satellite RAN Type(SAT-RANType)(2322), Regenerative Satellite Type(RATType)(2323), and UP Function Features(2324). According to an embodiment, UP Function Features may include Satellite Access Support(SSAT)(2325), NTN Proxy RAN Agent Support(SPRN)(2326), Store and Forward Support(SSAF)(2327), On-board Satellite Support(SOBS)(2328), and UE-Satellite-UE Communication Support(SUSU)(2329).

In response, UPF can transmit the following information to SMF through the N4 Association Setup Response message(2240): Satellite ID(SatID)(2241), Satellite RAN Type(SAT-RANType)(2242), Regenerative Satellite Type(RATType)(2243), and UP Function Features(2244). According to an embodiment, UP Function Features may include Satellite Access Support(SSAT)(2245), NTN Proxy RAN Agent Support(SPRN)(2246), Store and Forward Support(SSAF)(2247), On-board Satellite Support(SOBS)(2248), UE-Satellite-UE Communication Support(SUSU)(2249), and QoS/5QI for Satellite Access Support(SQOS)(2250).

Through this Association Setup procedure, SMF and UPF can verify each other's NTN support Features and perform session management based on them.

FIG. 23 illustrates a method for registration and search of AMF including NTN support functions according to an embodiment of this disclosure. Specifically, FIG. 23 illustrates in a flowchart the procedure for Access and Mobility Management Function(AMF) to register NTN support information with NRF and for other network functions to search for it.

Referring to FIG. 23, AMF can register NTN support information including NTN support functions with Network Repository Function(NRF) through Service Based Interface(SBI)(2310).

According to an embodiment, AMF can transmit access and mobility management function information(amfInfo) within NFProfile through the network function management registration/update request(Nnrf_NFManagement_Register/Update Request) message. The access and mobility management function information may include basic satellite access information such as Satellite Access Support(supportSAT), Satellite ID(SatID), AMF IP address(IPaddress), Satellite RAN Type(SAT-RANType), and Regenerative Satellite Type(RATType). It may also include information indicating support for additional functions such as NTN Proxy RAN Agent Support(supportProxyRAN), Store and Forward Support(supportStoreAndForward), On-board Satellite Support(supportOnBoardSAT), UE-Satellite-UE Communication Support(supportUE-SAT-UE), QoS/5QI for Satellite Access Support(supportQoS5QIforSAT), and Feeder Link Switchover Support(supportFeederLinkSwitch).

Next, other Network Functions(NF) can search for AMF including NTN support functions from the NRF through SBI(2320). According to an embodiment, NF transmits query parameters to the NRF through the network function discovery request(Nnrf_NFDiscovery Request) message. The query parameters can be configured by specifying the AMF type and satellite access support, such as “NFType=AMF&supportSAT=true”. In response, the NRF can transmit search results(SearchResult) or error information(ProblemDetails), and the search results can be delivered as a ‘200 OK’ response when successful, or as ‘4xx/5xx’ error codes or ‘3xx’ redirection responses when unsuccessful.

Through these registration and search procedures, AMF registers its NTN-related functions with the NRF, and other network functions can search for and utilize AMF with the necessary NTN support functions. This can contribute to efficiently integrating and operating satellite-based non-terrestrial networks in 5G systems.

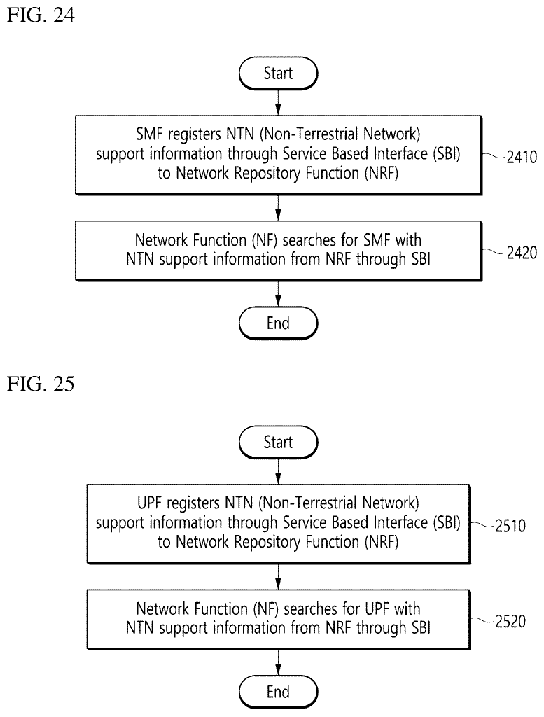

FIG. 24 illustrates a method for registration and search of SMF including NTN support functions according to an embodiment of this disclosure. Specifically, FIG. 24 illustrates in a flowchart the procedure for Session Management Function(SMF) to register NTN support information with NRF and for other network functions to search for it.

Referring to FIG. 24, SMF can register NTN support information including NTN support functions with Network Repository Function(NRF) through Service Based Interface(SBI)(2410). According to an embodiment, SMF can transmit session management function information(smfInfo) within NFProfile through the network function management registration/update request(Nnrf_NFManagement_Register/Update Request) message. The session management function information may include basic satellite access information such as Satellite Access Support(supportSAT), Satellite ID(SatID), SMF IP address(IPaddress), Satellite RAN Type(SAT-RANType), and Regenerative Satellite Type(RATType). It may also include information indicating support for additional functions such as NTN Proxy RAN Agent Support(supportProxyRAN), Store and Forward Support(supportStoreAndForward), On-board Satellite Support(supportOnBoardSAT), UE-Satellite-UE Communication Support(supportUE-SAT-UE), QoS/5QI for Satellite Access Support(supportQoS5QIforSAT), and Feeder Link Switchover Support(supportFeederLinkSwitch).

Next, other Network Functions(NF) can search for SMF including NTN support functions from the NRF through SBI(2420). According to an embodiment, NF can transmit query parameters to the NRF through the network function discovery request(Nnrf_NFDiscovery Request) message. The query parameters can be configured by specifying the SMF type and satellite access support, such as “NFType=SMF&supportSAT=true”. In response, the NRF can transmit search results(SearchResult) or error information(ProblemDetails), and the search results can be delivered as a ‘200 OK’ response when successful, or as ‘4xx/5xx’ error codes or ‘3xx’ redirection responses when unsuccessful.

Through these registration and search procedures, SMF registers its NTN-related functions with the NRF, and other network functions can search for and utilize SMF with the necessary NTN support functions. This can contribute to efficiently integrating and operating satellite-based non-terrestrial networks in 5G systems.

FIG. 25 illustrates a method for registration and search of UPF including NTN support functions according to an embodiment of this disclosure. Specifically, FIG. 25 illustrates in a flowchart the procedure for User Plane Function(UPF) to register NTN support information with NRF and for other network functions to search for it.

Referring to FIG. 25, UPF can register NTN support information including NTN support functions with Network Repository Function(NRF) through Service Based Interface(SBI)(2510). According to an embodiment, UPF can transmit user plane function information(upfInfo) within

NFProfile through the network function management registration/update request(Nnrf_NFManagement_Register/Update Request) message. The user plane function information may include basic satellite access information such as Satellite ID(SatID), UPF IP address(IPaddress), Satellite RAN Type(SAT-RANType), and Regenerative Satellite Type(RATType). It may also include UP Function Features through supported PFCP features(supportedPfcpFeatures), which may include Satellite Access Support(SSAT), NTN Proxy RAN Agent Support(SPRN), Store and Forward Support(SSAF), On-board Satellite Support(SOBS), UE-Satellite-UE Communication Support(SUSU), QoS/5QI for Satellite Access Support(SQOS), and Feeder Link Switchover Support(SFLS).

Next, other Network Functions(NF) search for UPF including NTN support functions from the NRF through SBI(2520). According to an embodiment, NF transmits query parameters to the NRF through the network function discovery request(Nnrf_NFDiscovery Request) message. The query parameters can be configured by specifying the UPF type and satellite access support, such as “NFType=UPF&SSAT=true”. In response, the NRF can transmit search results(SearchResult) or error information(ProblemDetails), and the search results can be delivered as a ‘200 OK’ response when successful, or as ‘4xx/5xx’ error codes or ‘3xx’ redirection responses when unsuccessful.

Through these registration and search procedures, UPF registers its NTN-related functions with the NRF, and other network functions can search for and utilize UPF with the necessary NTN support functions. This can contribute to efficiently integrating and operating satellite-based non-terrestrial networks in 5G systems.

According to various embodiments of this disclosure, a method for providing NTN support function information in a 5G system may include: a step of AMF(Access and Mobility Management Function) with NTN support functions registering NTN support function information with NRF(Network Repository Function) through SBI(Service Based Interface); and a step of NF(Network Function) searching for AMF including NTN support function information from NRF through SBI.

According to an embodiment, AMF with NTN support functions may include amfInfo information [FIG. 9] containing NTN support function Attributes such as Satellite access support(supportSAT), Satellite ID(SatID), AMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), and Feeder link switchover support(supportFeederLinkSwitch).

According to an embodiment, the SBI interface used by AMF with NTN support functions to register amfInfo information containing NTN support function Attributes such as Satellite access support(supportSAT), Satellite ID(SatID), AMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), and Feeder link switchover support(supportFeederLinkSwitch) with the NRF may be Nnrf_NFManagement_Register Request or Nnrf_NFManagement_Update Request service.

According to an embodiment, the SBI interface used by NF(Network Function) to search for AMF including NTN support functions from NRF is Nnrf_NFDiscovery Request service, and the query parameters included in this service may include at least one of the NTN support function Attributes: Satellite access support(supportSAT), Satellite ID(SatID), AMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), or Feeder link switchover support(supportFeederLinkSwitch).

According to an embodiment, a method for providing NTN support function information in a 5G system may include: a step of SMF(Session Management Function) with NTN support functions registering NTN support function information with NRF(Network Repository Function) through SBI(Service Based Interface); and a step of NF(Network Function) searching for SMF including NTN support function information from NRF through SBI.

According to an embodiment, SMF with NTN support functions may include smfInfo information [FIG. 12] containing NTN support function Attributes such as Satellite access support(supportSAT), Satellite ID(SatID), SMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), and Feeder link switchover support(supportFeederLinkSwitch).

According to an embodiment, the SBI interface used by SMF with NTN support functions to register smfInfo information containing NTN support function Attributes such as Satellite access support(supportSAT), Satellite ID(SatID), SMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), and Feeder link switchover support(supportFeederLinkSwitch) with the NRF may be Nnrf_NFManagement_Register Request or Nnrf_NFManagement_Update Request service.

According to an embodiment, the SBI interface used by NF(Network Function) to search for SMF including NTN support functions from NRF is Nnrf_NFDiscovery Request service, and the query parameters included in this service may include at least one of the NTN support function Attributes: Satellite access support(supportSAT), Satellite ID(SatID), SMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), or Feeder link switchover support(supportFeederLinkSwitch).

According to various embodiments of this disclosure, a method for providing NTN support function information in a 5G system may include: a step of PCF(Policy Control Function) with NTN support functions registering NTN support function information with NRF(Network Repository Function) through SBI(Service Based Interface); and a step of NF(Network Function) searching for PCF including NTN support function information from NRF through SBI.

According to an embodiment, PCF with NTN support functions may include pcfInfo information [FIG. 15] containing NTN support function Attributes such as Satellite access support(supportSAT), Satellite ID(SatID), PCF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), and Feeder link switchover support(supportFeederLinkSwitch).

According to an embodiment, the SBI interface used by PCF with NTN support functions to register pcfInfo information containing NTN support function Attributes such as Satellite access support(supportSAT), Satellite ID(SatID), PCF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), and Feeder link switchover support(supportFeederLinkSwitch) with the NRF may be Nnrf_NFManagement_Register Request or Nnrf_NFManagement_Update Request service.

According to an embodiment, the SBI interface used by NF(Network Function) to search for PCF including NTN support functions from NRF is Nnrf_NFDiscovery Request service, and the query parameters included in this service may include at least one of the NTN support function Attributes: Satellite access support(supportSAT), Satellite ID(SatID), PCF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), NTN Proxy RAN agent support(supportProxyRAN), Store and forward support(supportStoreAndForward), on-board satellite support(supportOnBoardSAT), UE-satellite-UE communication support(supportUE-SAT-UE), QoS/5QI for satellite access support(supportQoS5QIforSAT), or Feeder link switchover support(supportFeederLinkSwitch).

According to various embodiments of this disclosure, a method for providing NTN support function information in a 5G system may include: a step of UPF(User Plane Function) with NTN support functions registering NTN support information with NRF(Network Repository Function) through SBI(Service Based Interface); and a step of NF(Network Function) searching for UPF including NTN support information from NRF through SBI.

According to an embodiment, UPF with NTN support functions may include upfInfo information [FIG. 18] containing NTN support function Attributes such as Satellite ID(SatID), AMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), and UP Function Features including NTN support functions.

According to an embodiment, the existing UP Function Features may include NTN support function Features such as Satellite access support(SSAT), NTN Proxy RAN agent support(SPRN), Store and forward support(SSAF), on-board satellite support(SOBS), UE-satellite-UE communication support(SUSU), QoS/5QI for satellite access support(SQOS), and Feeder link switchover support Feature as shown in UP Function Features [FIG. 20].

According to an embodiment, the SBI interface used by NF(Network Function) to search for UPF including NTN support functions from NRF is Nnrf_NFDiscovery Request service, and the query parameters included in this service may include at least one of the NTN support function Attributes: Satellite ID(SatID), AMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), and UP Function Features including NTN support functions such as Satellite access support(SSAT), NTN Proxy RAN agent support(SPRN), Store and forward support(SSAF), on-board satellite support(SOBS), UE-satellite-UE communication support(SUSU), QoS/5QI for satellite access support(SQOS), or Feeder link switchover support Feature.

According to various embodiments of this disclosure, a method for providing NTN support function information in a 5G system may include: a step of SMF(Session Management Function) verifying whether UPF includes NTN support function Features in the Association Setup procedure with UPF through the N4 interface.

According to an embodiment, the protocol used by SMF to verify whether UPF includes NTN support function Features such as Satellite ID(SatID), AMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), and UP Function Features including NTN support functions such as Satellite access support(SSAT), NTN Proxy RAN agent support(SPRN), Store and forward support(SSAF), on-board satellite support(SOBS), UE-satellite-UE communication support(SUSU), QoS/5QI for satellite access support(SQOS), and Feeder link switchover support Feature is the N4 PFCP(Packet Forward Control Protocol) with N4 Association Setup Request and N4 Association Setup Response messages, and these messages may include Satellite ID(SatID), AMF IPv4/IPv6 address(IPaddress), SAT RAN type(one of Transparent satellite RAN type or Regenerative satellite RAN type, SAT-RANType), Regenerative satellite(one of REGENERATIVE_MEO, REGENERATIVE_LEO, REGENERATIVE_GEO, REGENERATIVE_OTHERSAT types, RATType), and UP Function Features including NTN support functions such as Satellite access support(SSAT), NTN Proxy RAN agent support(SPRN), Store and forward support(SSAF), on-board satellite support(SOBS), UE-satellite-UE communication support(SUSU), QoS/5QI for satellite access support(SQOS), and Feeder link switchover support Feature.

According to an embodiment, the existing UP Function Features may include Satellite access support(SSAT), NTN Proxy RAN agent support(SPRN), Store and forward support(SSAF), on-board satellite support(SOBS), UE-satellite-UE communication support(SUSU), QoS/5QI for satellite access support(SQOS), and Feeder link switchover support Feature.

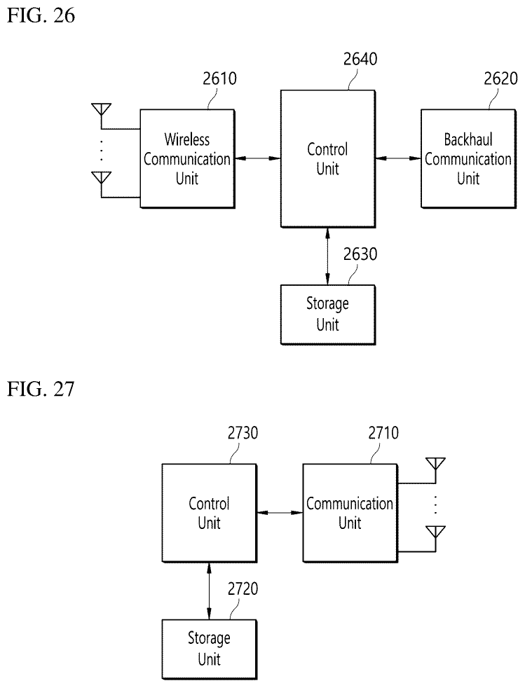

FIG. 26 illustrates a configuration of a base station in a wireless communication system according to various embodiments of this disclosure. The configuration illustrated in FIG. 26 can be understood as the configuration of a base station. The terms such as “ . . . unit”, “ . . . device”, etc. used below refer to units that process at least one function or operation, and these can be implemented in hardware or software, or a combination of hardware and software.

Referring to FIG. 26, the base station may include a wireless communication unit(2610), a backhaul communication unit(2620), a storage unit(2630), and a control unit(2640).

The wireless communication unit(2610) can transmit and receive wireless signals through wireless channels. For example, the wireless communication unit(2610) can perform conversion functions between baseband signals and bit sequences according to the physical layer specifications of the system. Additionally, when transmitting data, the wireless communication unit(2610) can generate complex symbols by encoding and modulating transmission bit sequences. When receiving data, the wireless communication unit(2610) can restore received bit sequences through demodulation and decoding of baseband signals.

The wireless communication unit(2610) can up-convert baseband signals to RF(radio frequency) band signals and transmit them through antennas, and down-convert RF band signals received through antennas to baseband signals. For this purpose, the wireless communication unit(2610) may include transmission filters, reception filters, amplifiers, mixers, oscillators, DAC(digital to analog convertor), and ADC(analog to digital convertor).

The wireless communication unit(2610) may include multiple transmission and reception paths, and the wireless communication unit(2610) may include at least one antenna array composed of multiple antenna elements.

From a hardware perspective, the wireless communication unit(2610) may include a digital unit and an analog unit, and the analog unit may include multiple sub-units depending on operating power, operating frequency, etc. The digital unit can be implemented with at least one processor (e.g., DSP(digital signal processor))

The wireless communication unit(2610) can transmit and receive wireless signals as described above. Accordingly, all or part of the wireless communication unit(2610) may be referred to as a “transmitter”, “receiver”, or “transceiver”. Also, in the following description, transmission and reception performed through wireless channels may include processing performed by the wireless communication unit(2610) as described above.

The backhaul communication unit(2620) can provide an interface for communication with other nodes in the network. That is, the backhaul communication unit(2620) can convert bit sequences transmitted from the base station to other nodes, such as other access nodes, other base stations, higher nodes, and core networks, into physical signals, and convert physical signals received from other nodes into bit sequences.

The storage unit(2630) can store data such as basic programs, applications, and setting information for the operation of the base station. The storage unit(2630) may be composed of volatile memory, non-volatile memory, or a combination of volatile and non-volatile memory. And the storage unit(2630) can provide stored data according to the request of the control unit(2640).

The control unit(2640) can control the overall operations of the base station. For example, the control unit(2640) can transmit and receive signals through the wireless communication unit(2610) or the backhaul communication unit(2620). Also, the control unit(2640) can write and read data to and from the storage unit(2630). Additionally, the control unit(2640) can perform the functions of the protocol stack required by communication specifications.

For this purpose, the control unit(2640) may include at least one processor.

According to various embodiments of this disclosure, the control unit(2640) can control to perform operations according to various embodiments performed by the base station described above.

FIG. 27 illustrates a configuration of a terminal in a wireless communication system according to various embodiments of this disclosure. The configuration illustrated in FIG. 27 can be understood as the configuration of a terminal. The terms such as “ . . . unit”, “ . . . device”, etc. used below refer to units that process at least one function or operation, and these can be implemented in hardware or software, or a combination of hardware and software.

Referring to FIG. 27, the terminal may include a communication unit(2710), a storage unit(2720), and a control unit(2730).

The communication unit(2710) can perform functions for transmitting and receiving signals through wireless channels. For example, the communication unit(2710) can perform conversion functions between baseband signals and bit sequences according to the physical layer specifications of the system. For example, when transmitting data, the communication unit(2710) can generate complex symbols by encoding and modulating transmission bit sequences. When receiving data, the communication unit(2710) can restore received bit sequences through demodulation and decoding of baseband signals. Additionally, the communication unit(2710) can up-convert baseband signals to RF band signals and transmit them through antennas, and down-convert RF band signals received through antennas to baseband signals. For example, the communication unit(2710) may include transmission filters, reception filters, amplifiers, mixers, oscillators, DAC, ADC, etc.

Also, the communication unit(2710) may include multiple transmission and reception paths. Furthermore, the communication unit(2710) may include at least one antenna array composed of multiple antenna elements. From a hardware perspective, the communication unit(2710) can be composed of digital circuits and analog circuits(e.g., RFIC(radio frequency integrated circuit)). Here, the digital circuits and analog circuits can be implemented as a single package. Also, the communication unit(2710) may include multiple RF chains. Furthermore, the communication unit(2710) can perform beamforming.

The communication unit(2710) transmits and receives signals as described above. Accordingly, all or part of the communication unit(2710) may be referred to as a “transmitter”, “receiver”, or “transceiver”. Also, in the following description, transmission and reception performed through wireless channels may be used to include the processing performed by the communication unit(2710) as described above.

The storage unit(2720) can store data such as basic programs, applications, and setting information for the operation of the terminal. The storage unit(2720) may be composed of volatile memory, non-volatile memory, or a combination of volatile and non-volatile memory. And the storage unit(2720) can provide stored data according to the request of the control unit(2730).

The control unit(2730) can control the overall operations of the terminal. For example, the control unit(2730) can transmit and receive signals through the communication unit(2710). Also, the control unit(2730) can write and read data to and from the storage unit(2720). The control unit(2730) can perform the functions of the protocol stack required by communication specifications. For this purpose, the control unit(2730) may include or be part of at least one processor or micro processor. Also, part of the communication unit(2710) and the control unit(2730) may be referred to as a CP(communication processor).

According to various embodiments, the control unit(2730) can control to perform operations according to various embodiments performed by the terminal described above.

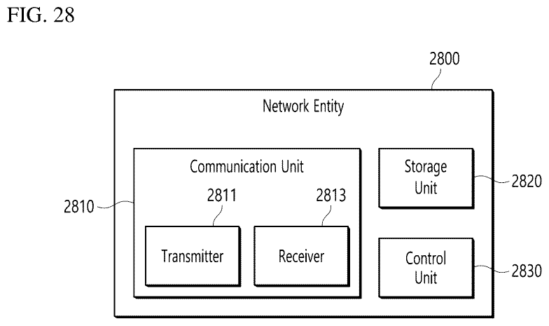

FIG. 28 illustrates a configuration of a network entity in a wireless communication system according to various embodiments of this disclosure. The network entity of this disclosure is a concept that includes network functions depending on system implementation. The terms such as “ . . . unit”, “ . . . device”, etc. used below refer to units that process at least one function or operation, and these can be implemented in hardware or software, or a combination of hardware and software.

According to various embodiments of this disclosure, the network entity(2800) may include a communication unit(2810), a storage unit(2820), and a control unit(2830) that controls the overall operation of the network entity(2800). The communication unit(2810) transmits and receives signals with other network entities. Accordingly, all or part of the communication unit(2810) may be referred to as a “transmitter(2811)”, “receiver(2813)”, or “transceiver(2810)”.

The storage unit(2820) stores data such as basic programs, applications, and setting information for the operation of the network entity(2800). The storage unit(2820) may be composed of volatile memory, non-volatile memory, or a combination of volatile and non-volatile memory. And the storage unit(2820) provides stored data according to the request of the control unit(2830).

The control unit(2830) controls the overall operations of the network entity(2800). For example, the control unit(2830) transmits and receives signals through the communication unit(2810). Also, the control unit(2830) writes and reads data to and from the storage unit(2820). And the control unit(2830) can perform the functions of the protocol stack required by communication specifications. For this purpose, the control unit(2830) may include or be part of a circuit, an application-specific circuit, at least one processor or microprocessor. Also, part of the communication unit(2810) and the control unit(2830) may be referred to as a CP(communication processor).

The control unit(2830) can control the network entity(2800) to perform any one of the operations according to various embodiments of this disclosure. It is of course that the communication unit(2810) and the control unit(2830) do not necessarily have to be implemented as separate modules, and can be implemented as a single component in the form of a single chip or software block. The communication unit(2810), storage unit(2820), and control unit(2830) can be electrically connected.

Also, the operations of the network entity(2800) can be realized by equipping the network entity(2800) with the storage unit(2820) that stores the corresponding program code. The network entity(2800) includes a network node, and can be any one of Radio Access Network(RAN), Access and Mobility Management Function(AMF), Session Management Function(SMF), User Plane Function(UPF), Network Function(NF), Network Exposure Function(NEF), Network Repository Function(NRF), Policy Control Function(PCF), Network Slice Selection Function(NSSF), Unified Data Management(UDM), Application Function(AF), Authentication Server Function(AUSF), Service Communication Proxy(SCP), Unstructured Data Storage Function(UDSF), Edge Application Server Discovery Function(EASDF).

The methods according to the embodiments described in the claims or specification of this disclosure can be implemented in the form of hardware, software, or a combination of hardware and software.

When implemented in software, a computer-readable storage medium storing one or more programs(software modules) may be provided. One or more programs stored in the computer-readable storage medium are configured for execution by one or more processors within an electronic device. The one or more programs include instructions that cause the electronic device to execute methods according to the embodiments described in the claims or specification of this disclosure.

Such programs(software modules, software) can be stored in random access memory, non-volatile memory including flash memory, read only memory(ROM), electrically erasable programmable read only memory(EEPROM), magnetic disc storage device, compact disc-ROM (CD-ROM), digital versatile discs(DVDs) or other forms of optical storage devices, magnetic cassettes. Alternatively, they can be stored in memory composed of a combination of some or all of these. Also, each constituent memory may include multiple instances.

Additionally, programs can be stored in attachable storage devices that can be accessed through communication networks such as the Internet, Intranet, LAN(local area network), WAN (wide area network), or SAN(storage area network), or communication networks composed of combinations of these. Such storage devices can be connected to the device performing the embodiments of this disclosure through external ports. Also, separate storage devices on the communication network may be connected to the device performing the embodiments of this disclosure.

In the specific embodiments of this disclosure described above, components included in the disclosure were expressed in singular or plural according to the specific embodiments presented. However, the singular or plural expressions are selected appropriately for the situations presented for convenience of explanation, and this disclosure is not limited to singular or plural components. Components expressed in plural may be configured in singular, and components expressed in singular may be configured in plural.

Meanwhile, although specific embodiments have been described in the detailed description of this disclosure, various modifications are possible within limits that do not deviate from the scope of this disclosure. Therefore, the scope of this disclosure should not be determined to be limited to the described embodiments, but should be determined by the scope of the patent claims described below, as well as equivalents to the scope of these patent claims.

What is claimed is:

1. A method performed by an Access and Mobility Management Function (AMF) for providing Non-Terrestrial Network (NTN) support function information in a wireless communication system, the method comprising: registering NTN support information including NTN support functions by the AMF to a Network Repository Function (NRF) through a Service Based Interface (SBI); enabling another Network Function (NF) to search for the AMF including NTN support functions from the NRF through the SBI.

2. The method of claim 1, wherein the NTN support information includes Satellite access support (supportSAT), Satellite ID (SatID), AMF IPv4/IPv6 address (IPaddress), SAT RAN type (one of Transparent satellite RAN type or Regenerative satellite RAN type, SAT-RANType), Regenerative satellite (one of REGENERATIVE_MEO, REGENERATIVE_LEO, REGENERATIVE_GEO, REGENERATIVE_OTHERSAT types, RATType), NTN Proxy RAN agent support (supportProxyRAN), Store and forward support (supportStoreAndForward), on-board satellite support (supportOnBoardSAT), UE-satellite-UE communication support (supportUE-SAT-UE), QoS/5QI for satellite access support (supportQoS5QIforSAT), and Feeder link switchover support (supportFeederLinkSwitch).

3. The method of claim 1, wherein the step of the AMF registering the NTN support information uses NRF network function management registration request (Nnrf_NFManagement_Register Request) or NRF network function management update request (Nnrf_NFManagement_Update Request) service.

4. The method of claim 1, wherein the step of the NF searching for the AMF includes transmitting a network function discovery request (Nnrf_NFDiscovery Request) to the NRF, and specifying NTN support functions as query parameters.

5. The method of claim 4, wherein the query parameters of the network function discovery request include an identifier indicating that the network function type is AMF (NFType=AMF) and the NTN support information.

6. A method performed by a Session Management Function (SMF) for providing Non-Terrestrial Network support function information in a wireless communication system, the method comprising: registering NTN (Non-Terrestrial Network) support information by the SMF to a Network Repository Function (NRF) through a Service Based Interface (SBI); and enabling a Network Function (NF) to search for the SMF having the NTN support information from the NRF through the SBI.

7. The method of claim 6, wherein the NTN support information registered by the SMF includes Satellite access support (supportSAT), Satellite ID (SatID), SMF IPv4/IPv6 address (IPaddress), SAT RAN type (one of Transparent satellite RAN type or Regenerative satellite RAN Regenerative type, SAT-RANType), satellite (one of REGENERATIVE_MEO, REGENERATIVE_LEO, REGENERATIVE_GEO, REGENERATIVE_OTHERSAT types, RATType), NTN Proxy RAN agent support (supportProxyRAN), Store and forward support (supportStoreAndForward), on-board satellite support (supportOnBoardSAT), UE-satellite-UE communication support (supportUE-SAT-UE), QoS/5QI for satellite access support (supportQoS5QIforSAT), and Feeder link switchover support (supportFeederLinkSwitch).

8. The method of claim 6, wherein the step of the SMF registering the NTN support information uses NRF network function management registration request (Nnrf_NFManagement_Register Request) or NRF network function management update request (Nnrf_NFManagement_Update Request) service.

9. The method of claim 6, wherein the step of the NF searching for the SMF includes transmitting a network function discovery request (Nnrf_NFDiscovery Request) to the NRF, and specifying the NTN support functions as query parameters.

10. The method of claim 9, wherein the query parameters of the network function discovery request (Nnrf_NFDiscovery Request) include an identifier indicating that the network function type is SMF and the NTN support information.

11. A method performed by a User Plane Function (UPF) for providing Non-Terrestrial Network support function information in a wireless communication system, the method comprising: registering NTN (Non-Terrestrial Network) support information by the UPF to a Network Repository Function (NRF) through a Service Based Interface (SBI); and enabling a Network Function (NF) to search for the UPF having the NTN support information from the NRF through the SBI.

12. The method of claim 11, wherein the NTN support information registered by the UPF includes Satellite ID (SatID), AMF IPv4/IPv6 address (IPaddress), SAT RAN type (one of Transparent satellite RAN type or Regenerative satellite RAN type, SAT-RANType), Regenerative satellite (one of REGENERATIVE_MEO, REGENERATIVE_LEO, REGENERATIVE_GEO, REGENERATIVE_OTHERSAT types, RATType), and UP Function Features including Satellite access support (SSAT), NTN Proxy RAN agent support (SPRN), Store and forward support (SSAF), on-board satellite support (SOBS), UE-satellite-UE communication support (SUSU), QoS/5QI for satellite access support (SQOS), and Feeder link switchover support Feature.

13. The method of claim 11, wherein the step of the UPF registering the NTN support information uses NRF network function management registration request (Nnrf_NFManagement_Register Request) or NRF network function management update request (Nnrf_NFManagement_Update Request) service.

14. The method of claim 11, wherein the step of the NF searching for the UPF includes transmitting a network function discovery request (Nnrf_NFDiscovery Request) to the NRF, and specifying the NTN support functions as query parameters.

15. The method of claim 14, wherein the query parameters of the network function discovery request (Nnrf_NFDiscovery Request) include an identifier indicating that the network function type is UPF and supported packet forwarding control protocol features (supportedPfcpFeatures).
